(19) United States
(12) Patent Application Publication
(10) Pub. No.: US 2018/0043431 A1
(43) Pub. Date: Feb. 15, 2018

(54) MAGNETIC CORE POWDER, DUST CORE, AND METHOD FOR PRODUCING MAGNETIC CORE POWDER

(71) Applicant: NTN CORPORATION, Osaka (JP)

(72) Inventors: Hikaru ARAKI, Mie (JP); Noritaka KAKO, Mie (JP); Kouya OOHIRA, Mie (JP)

(73) Assignee: NTN CORPORATION, Osaka (JP)

(21) Appl. No.: 15/557,979

(22) PCT Filed: Feb. 24, 2016
(86) PCT No.: PCT/JP2016/055429

§ 371 Date: Sep. 13, 2017

(30) Foreign Application Priority Data
Mar. 24, 2015 (JP) 2015-061001

(51) Int. Cl. B22F 1/00; B22F 1/02; B22F 3/02; H01F 27/255; H01F 1/153; H01F 1/24; H01F 1/33; B22F 9/02; B22F 3/24

(52) U.S. Cl. CPC B22F 1/0062; B22F 9/02; B22F 1/02; B22F 3/02; B22F 3/24; H01F 1/153; H01F 1/24; H01F 1/33; H01F 27/255; B22F 2301/35; B22F 2003/248

(57) ABSTRACT

Provided is a powder (A) for a magnetic core for producing a powder magnetic core, the powder (A) for a magnetic core including: as a main component a granulated powder (1) obtained by granulating iron-based amorphous powder having been subjected to insulation treatment and having a particle size distribution falling within a range of from 1 μm to 200 μm; and glass powder having a softening point lower than a temperature of the annealing treatment. The granulated powder (1) is obtained by binding particles (2) of magnetic powder each formed of a particle (3) of the iron-based amorphous powder and an insulating coating (4) configured to coat the surface of the particle (3) to each other through use of a PVA aqueous solution having a viscosity of from 3 mPa·s to 25 mPa·s.

### TECHNICAL FIELD

The present invention relates to a powder for a magnetic core and a powder magnetic core, and to a method of producing a powder for a magnetic core.

### BACKGROUND ART

A powder magnetic core is used as a core of an electromagnetic component, such as a reactor or a choke coil, and is obtained, for example, by performing annealing treatment on a compact formed of a powder for a magnetic core including, as a main raw material (main component), soft magnetic metal powder having been subjected to insulation treatment (in which the surfaces of particles are each coated with an insulating coating). In recent years, such powder magnetic core has been used frequently because the powder magnetic core has the advantages of, for example, having a high degree of freedom of a shape and being easy to respond to a request for miniaturization and a complicated shape.

In particular, out of the powder magnetic cores, in production of a powder magnetic core for use in a high-frequency region of from several ten kilohertz to several hundred kilohertz, iron-based alloy powder, such as Fe—Si powder, Fe—Ni (permalloy) powder, Fe—Si—Al (sendust) powder, or iron-based amorphous powder, rather than pure iron powder, is preferably used as the soft magnetic metal powder. This is mainly because the iron-based alloy powder as a material itself has a higher resistivity than the pure iron powder, and hence an eddy-current loss (iron loss) can be reduced in the high-frequency region. However, the iron-based alloy powder has a high hardness and thus exhibits poor plastic deformability during compression molding as compared to the pure iron powder. As a result, it is necessary to increase a molding pressure during the compression molding for obtaining a compact having a high density, and by extension, a powder magnetic core excellent in strength and magnetic characteristics (particularly, magnetic permeability and magnetic flux density). However, when the molding pressure during the compression molding is immoderately increased, the insulating coating configured to coat the surfaces of the particles is liable to suffer from damage or the like, and hence it becomes difficult to stably obtain a low-loss powder magnetic core having a low eddy-current loss. In view of the foregoing, for example, in Patent Literature 1 described below, there has been proposed technical means for enabling production of the low-loss powder magnetic core involving using a powder for a magnetic core including particularly, out of the iron-based alloy powders, the iron-based amorphous powder as a main raw material.

The technical means disclosed in Patent Literature 1 involves producing a compact through use of a mixture of the iron-based amorphous powder (“amorphous soft magnetic alloy powder” in Patent Literature 1), glass powder having a softening point lower than the crystallization temperature of the iron-based amorphous powder, and a PVA aqueous solution or a PVB solution containing PVA or PVB serving as a binder resin (substantially, granulated powder obtained by granulating the mixture), followed by subjecting the compact to annealing treatment at a temperature lower than the crystallization temperature of the iron-based amorphous powder. With such configuration, the following actions and effects are exhibited.

(1) A PVA coating or a PVB coating, which is formed so as to coat the surfaces of the particles of the iron-based amorphous powder and the glass powder in the course of production of the granulated powder, functions as a binder configured to bind the particles of the granulated powder to each other, and hence a compact which has high shape stability and is excellent in handling property can be obtained.
(2) When the compact is annealed under the above-mentioned conditions, PVA or PVB is not completely thermally decomposed and part thereof remains. The remaining part serves as an insulating coating configured to coat the surfaces of the particles of the iron-based amorphous powder. In addition, when the compact including the above-mentioned glass powder is subjected to the annealing treatment under the above-mentioned conditions, the particles of the iron-based amorphous powder can be prevented from being brought into contact with each other to the extent possible. As a result, a low-loss powder magnetic core having a low eddy-current loss can be obtained.

While Patent Literature 1 makes no particular mention, PVA, for which water (pure water) can be used as a solvent, has the advantages of having a small adverse effect on a human body and having a low environmental load as compared to other binder resins required to be dissolved in an organic solvent including an alcohol or toluene, such as PVB, an acrylic resin, an epoxy resin, a silicone resin, or a modified product thereof.

### CITATION LIST

Patent Literature 1: JP 2010-27854 A

### SUMMARY OF INVENTION

### Technical Problem

Patent Literature 1 can be said to provide effective technical means to enable production of the low-loss powder magnetic core. However, in Patent Literature 1, only technical means aimed primarily at “reducing the loss of the powder magnetic core” is disclosed, and sufficient investigations have not been made on technical means for increasing the magnetic flux density of the powder magnetic core. It is desired that the magnetic flux density of the powder magnetic core be as high as possible because the output of various devices, in each of which the powder magnetic core is to be incorporated, increases or decreases in proportion to the magnetic flux density of the powder magnetic core.

In view of the above-mentioned circumstances, a primary object of the present invention is to enable production of a compact which has a high density and is excellent in handling property, and by extension, a powder magnetic core which has high strength and is excellent in magnetic characteristics (particularly, magnetic flux density), even when iron-based amorphous powder is contained as a main component.

### Solution to Problem

As a result of extensive investigations, the inventors of the present invention have found that the viscosity of a PVA aqueous solution to be used in a production stage of granulated powder of iron-based amorphous powder has a large influence on a granulation effect, and by extension, on moldability of a compact and magnetic characteristics of a powder magnetic core. The inventors have also found that a powder magnetic core excellent in strength and magnetic characteristics can be produced by controlling the viscosity of the PVA aqueous solution within a predetermined range. Thus, the present invention has been devised.

That is, according to one embodiment of the present invention, which has been devised on the basis of such finding, there is provided a powder for a magnetic core for producing a powder magnetic core through annealing treatment of a compact, the powder for a magnetic core comprising: as a main component granulated powder obtained by granulating iron-based amorphous powder having been subjected to insulation treatment and having a particle size distribution falling within a range of from 1 μm to 200 μm; and glass powder having a softening point lower than a temperature of the annealing treatment, wherein the granulated powder is obtained by binding particles of the iron-based amorphous powder to each other through use of a PVA aqueous solution having a viscosity of from 3 mPa·s to 25 mPa·s.

The “having a particle size distribution falling within a range of from 1 μm to 200 μm” as used herein has the same meaning as containing particles each having a particle diameter of from 1 μm to 200 μm, and the “the iron-based amorphous powder having been subjected to insulation treatment” as used herein has the same meaning as the iron-based amorphous powder each having a surface coated with an insulating coating. In addition, the “viscosity” as used herein refers to a viscosity measured by a method specified in JIS Z 8803:2011, and more specifically, to a viscosity measured with a rotational viscometer operated at 60 rpm in an environment at 25° C.

The iron-based amorphous powder having a particle size distribution falling within a range of from 1 μm to 200 μm contains fine particles each having a particle diameter of about 20 μm or less. Such fine particles contribute to an increase in density of a compact, and by extension, improvements in magnetic characteristics of a powder magnetic core. However, the fine particles alone have poor fluidity and hence have an adverse effect on moldability of the compact. In contrast, as in the present invention, when the granulated powder is produced through use of the PVA aqueous solution having a viscosity falling within the above-mentioned numerical range (PVA aqueous solution having a relatively low viscosity), the granulated powder is not coarse one in which a particle diameter is increased up to about not less than several hundred micrometers by binding a number of large-diameter particles (for example, particles each having a particle diameter of 50 μm or more) to each other, and is predominantly one having such a moderate size that the large-diameter particles wear the fine particles. Therefore, the use of the powder for a magnetic core according to the present invention enables production of a compact having a high density, and by extension, a powder magnetic core excellent in magnetic characteristics (particularly, magnetic flux density).

In addition, part of the PVA aqueous solution does not contribute to granulation and serves as a coating (PVA coating) configured to coat the surfaces of the particles of the iron-based amorphous powder after drying (after elimination of a solvent). As a result, the surface of the granulated powder is almost entirely coated with the PVA coating. The coating is excellent in adhesiveness to others, and hence contributes to an improvement in shape retention property (chipping resistance) of the compact. Further, the powder for a magnetic core according to the present invention comprises the glass powder having a softening point lower than a temperature of the annealing treatment, and hence when a compact formed of the powder for a magnetic core is subjected to annealing treatment, the glass powder softens and melts, and is then solidified between the adjacent particles of the granulated powder, to thereby increase a binding force between the adjacent particles. Thus, a powder magnetic core which has high strength and is excellent in handling property can be obtained.

The glass powder in the powder for a magnetic core may be dispersed in the granulated powder or supported on the granulated powder. When the glass powder is supported on the granulated powder, variation in strength in each powder magnetic core and further variation between powder magnetic cores can be prevented to the extent possible.

It is preferred that the powder for a magnetic core comprise the glass powder so that a weight ratio of the glass powder with respect to the iron-based amorphous powder is set to from 0.1 wt % to 1 wt %. The reason for this is as follows: when the weight ratio of the glass powder with respect to the iron-based amorphous powder is less than 0.1 wt %, the strength of the powder magnetic core cannot be increased sufficiently, and when the weight ratio of the glass powder with respect to the iron-based amorphous powder is more than 1.0 wt %, it becomes difficult to ensure a magnetic permeability required for the powder magnetic core.

The glass powder to be used may comprise as a main component bismuth oxide (Bi₂O₃) and boron oxide (B₂O₃).

By virtue of the powder for a magnetic core according to the present invention having the above-mentioned features, the powder magnetic core obtained by performing the annealing treatment on the compact formed of the powder for a magnetic core has a high density and high strength, is excellent in handling property and durability, and is excellent in magnetic characteristics (particularly, magnetic flux density).

According to another embodiment of the present invention, there is provided a method of producing a powder for a magnetic core for producing a powder magnetic core through annealing treatment of a compact, the powder for a magnetic core comprising: as a main component granulated powder obtained by granulating iron-based amorphous powder having been subjected to insulation treatment and having a particle size distribution falling within a range of from 1 μm to 200 μm; and glass powder having a softening point lower than a temperature of the annealing treatment, the method comprising producing the granulated powder by binding particles of the iron-based amorphous powder to each other through use of a PVA aqueous solution having a viscosity of 3 mPa·s or more and 25 mPa·s or less.

In the production of the granulated powder, the binding of the particles of the iron-based amorphous powder to each other may be performed by eliminating a solvent component of the PVA aqueous solution supplied into a container in which the iron-based amorphous powder is stirred in a floating state. In this case, the PVA aqueous solution to be used may have dispersed therein the glass powder.

### Advantageous Effects of Invention

As described above, according to the present invention, the compact which has a high density and is excellent in handling property, and by extension, the powder magnetic core which has high strength and is excellent in magnetic characteristics (particularly, magnetic flux density) can be produced, even when the iron-based amorphous powder is contained as a main component.

### BRIEF DESCRIPTION OF DRAWINGS

FIG. 1A is a view for schematically illustrating granulated powder contained in a powder for a magnetic core according to the present invention.

FIG. 1B is a view for schematically illustrating a particle of magnetic powder constituting the granulated powder illustrated in FIG. 1A.

FIG. 2 is a view for schematically illustrating a tumbling fluidized bed apparatus to be used in a granulation step.

FIG. 3A is a view for schematically illustrating an initial stage of a compression molding step.

FIG. 3B is a view for schematically illustrating an intermediate stage of the compression molding step.

FIG. 4 is a schematic perspective view of a core for a choke coil, which is an example of a powder magnetic core.

FIG. 5 is a view for schematically illustrating a modified example of the granulated powder contained in the powder for a magnetic core according to the present invention.

FIG. 6 is a view for schematically illustrating an example of granulated powder produced without applying the present invention.

### DESCRIPTION OF EMBODIMENTS

Now, embodiments of the present invention are described with reference to the drawings.

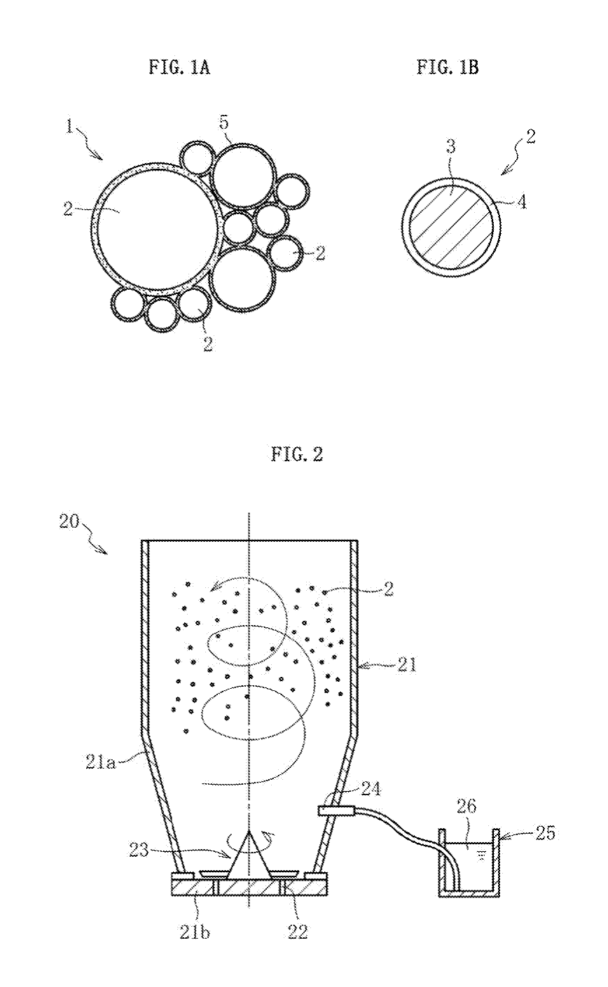

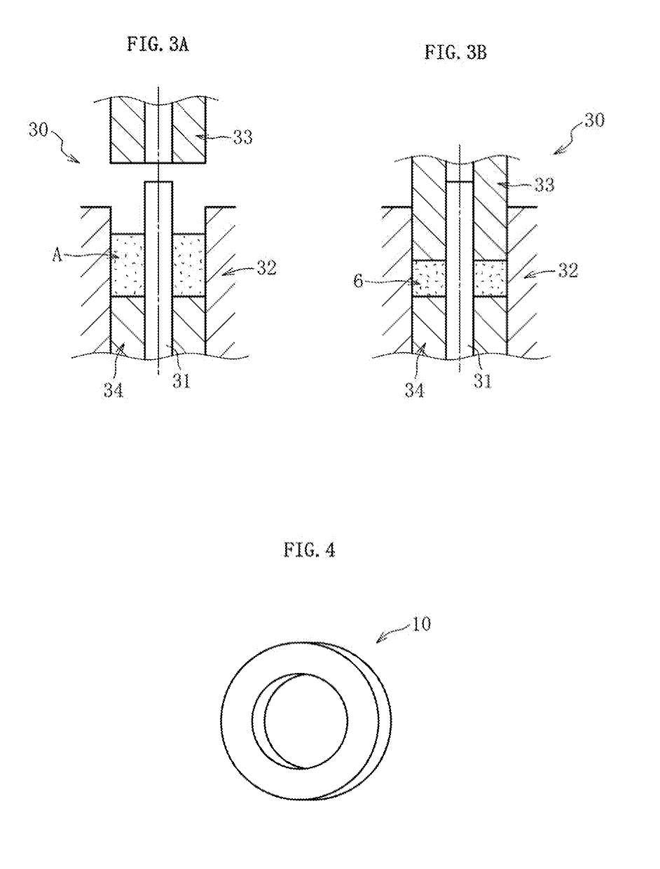

A powder A for a magnetic core according to the present invention (see FIG. 3A) is used as raw material powder in production of a powder magnetic core, such as a core 10 for a choke coil (see FIG. 4). The powder A for a magnetic core comprises a granulated powder 1 as a main component and a predetermined amount of glass powder. As illustrated in FIG. 1A, each of the granulated powder 1 are obtained by binding particles 2 of magnetic powder to each other with a resin part 5 in a coating form. In addition, the core 10 as a powder magnetic core is manufactured, for example, through a granulation step, a mixing step, a compression molding step, and an annealing step in this order. The steps are described in detail below.

[Granulation Step]

In the granulation step, for example, the granulated powder 1 is produced by using a tumbling fluidized bed apparatus (also called “tumbling fluidized bed coating apparatus”) 20 as schematically illustrated in FIG. 2. The tumbling fluidized bed apparatus 20 illustrated in FIG. 2 comprises a container 21 having a bottomed cylindrical shape including a tubular portion 21a and a bottom portion 21b, one or a plurality of blast ports 22 opened in a bottom surface in the container, a propeller 23, which is mounted at the center of the bottom portion 21b of the container 21 and rotates with an axial direction of the container 21 being a rotation center, a spray nozzle 24 mounted on the tubular portion 21a of the container 21, and a housing tank 25 for a spray object to be sprayed through the spray nozzle 24.

In the production of the granulated powder 1 with the tumbling fluidized bed apparatus 20 having the above-mentioned configuration, first, the magnetic powder is loaded into the container 21, and a binder solution 26 serving as a material for forming the resin part 5 in a coating form is filled in the housing tank 25. The magnetic powder to be loaded into the container 21 is iron-based amorphous powder having been subjected to preliminary insulation treatment. Therefore, as schematically illustrated in FIG. 1B, the particles 2 of the magnetic powder are each formed of a particle 3 of the iron-based amorphous powder and an insulating coating 4 configured to coat the surface of the particle 3. An example of the iron-based amorphous powder to be used is powder having an Fe—Cr—Si—B—C-based composition and having a particle size distribution falling within a range of from 1 μm to 200 μm (containing particles each having a particle diameter of from 1 μm to 200 μm).

A material for forming the insulating coating 4 is not particularly limited as long as the material is generally used for the powder magnetic core (the material can form a coating having a thickness of from about several nanometers to about several tens of nanometers), and the insulating coating 4 may be formed by using, for example: an oxide containing at least one kind of element selected from the group consisting of B, Ca, Mg, Al, Si, Ti, V, Cr, Mn, Fe, Co, Ni, Zn, Y, Zr, Mo, and Bi; a carbonate containing at least one kind of element selected from the group consisting of Li, K, Ca, Na, Mg, Fe, Al, Zn, and Mn; a silicate containing at least one kind of element selected from the group consisting of Ca, Al, Zr, Li, Na, and Mg; an alkoxide containing at least one kind of element selected from the group consisting of Si, Ti, and Zr, a phosphate containing at least one kind of element selected from the group consisting of Zn, Fe, Mn, and Ca; or a resin material excellent in heat resistance, such as a silicone resin, an epoxy resin, a polyimide resin, a PPS resin, or a PTFE resin. The insulating coating 4 may be formed by using only one kind or two or more kinds of the coating formation materials described above as examples. That is, the insulating coating 4 may have a single layer structure, or may have a laminate structure in which two or more kinds of coatings are laminated.

The binder solution 26 is a PVA aqueous solution obtained by dissolving polyvinyl alcohol (PVA), which is a material for forming the resin part 5, in water as a solvent. More specifically, a PVA aqueous solution having a viscosity falling within a range of from 3 mPa·s to 25 mPa·s is selected and used. The PVA aqueous solution having such viscosity is obtained, for example, by dissolving PVA adjusted to have a polymerization degree of from 100 to 1,000 and a saponification degree of from 50 mol % to 100 mol % in water as a solvent at from 5 wt % to 15 wt % with respect to water. As described above, the “viscosity” as used herein refers to a viscosity measured by a method specified in JIS Z 8803:2011, and more specifically, to a viscosity measured with a rotational viscometer operated at 60 rpm in an environment at 25° C. For example, TVB-10 viscometer manufactured by Toki Sangyo Co., Ltd may be used as the rotational viscometer.

Then, when the propeller 23 is rotated while air is supplied into the container 21 through the blast ports 22, an airstream as indicated by the helical arrow in FIG. 2 is generated, and along with this, the magnetic powder 2 (particles 2 of the magnetic powder) loaded into the container 21 is stirred in a floating state. When, with this state kept, the binder solution 26 is sprayed into the container 21 as a mist through the spray nozzle 24, the binder solution 26 adheres onto the surfaces of the particles 2 of the magnetic powder, and thus the particles 2 of the magnetic powder are bound to each other with the binder solution 26. Then, when the tumbling fluidized bed apparatus 20 is operated continuously, the solvent (water) of the binder solution 26 is eliminated, and thus the granulated powder 1 in which the particles 2 of the magnetic powder are bound to each other with the resin part 5 (PVA coating) is obtained. When the granulated powder 1 is produced with the tumbling fluidized bed apparatus 20 as described above, the binding between the particles 2 of the magnetic powder with the binder solution 26 and drying treatment of the binder solution 26 can be performed simultaneously, with the result that the granulated powder 1 can efficiently be produced. For example, a tumbling fluidized bed coating apparatus MP-01 manufactured by Powrex Corp. may be used as the tumbling fluidized bed apparatus 20.

The magnetic powder to be used in this embodiment comprises as a base material the iron-based amorphous powder having a particle size distribution falling within a range of from 1 μm to 200 μm. Such magnetic powder contains fine particles each having a particle diameter of about 20 μm or less. When the low-viscosity PVA aqueous solution having a viscosity falling within a range of from 3 mPa·s to 25 mPa·s is used as the binder solution 26 in the production of the granulated powder 1 as in this embodiment, the granulated powder 1 is not coarse one in which a particle diameter is increased up to about not less than several hundred micrometers by binding a number of large-diameter particles 2 (for example, particles each having a particle diameter of 50 μm or more) contained in the magnetic powder to each other, and is predominantly one having such a moderate particle diameter that the large-diameter particles 2 wear fine particles 2 (see FIG. 1A). Specifically, when the viscosity of the PVA aqueous solution serving as the binder solution 26 is more than 25 mPa·s, the coarse granulated powder 1 as described above is liable to be formed, and meanwhile, when the viscosity of the PVA aqueous solution is less than 3 mPa·s, a binding force between the particles 2 is reduced, and it becomes difficult to obtain the desired granulated powder 1. Therefore, as described above, the PVA aqueous solution having a viscosity falling within a range of from 3 mPa·s to 25 mPa·s is used as the binder solution 26 in the production of the granulated powder 1.

The particle diameter of the granulated powder 1 produced as described above is affected by a spray amount of the binder solution 26, a spray time period of the binder solution 26 (operation time period of the tumbling fluidized bed apparatus 20), or the like, as well as by the viscosity of the binder solution 26. The spray amount and spray time period of the binder solution 26 are adjusted and set so that the granulated powder 1 has an average particle diameter of 40 μm or more and 180 μm or less.

Part of the binder solution 26 used in the production of the granulated powder 1 does not contribute to granulation and serves as the PVA coating configured to coat the surfaces of the particles 2 of the magnetic powder after drying. As a result, as illustrated in FIG. 1A, the surface of each particle of the granulated powder 1 is almost entirely coated with the resin part 5.

[Mixing Step]

The mixing step involves allowing a predetermined amount of glass powder to be added to and mixed with an indefinite number of the granulated powder 1 obtained in the granulation step to provide the powder A for a magnetic core. The glass powder is added and mixed at a ratio of from 0.1 wt % to 1.0 wt % with respect to (the total amount of) the granulated powder 1. Glass powder having a relatively low melting point, for example, one kind or two or more kinds selected from the group consisting of TeO₂-based powder, V₂O₅-based powder, SnO-based powder, ZnO-based powder, P₂O₅-based powder, PbO-based powder, SiO₂-based powder, B₂O₃-based powder, Bi₂O₃-based powder, Al₂O₃-based powder, and TiO₂-based powder may be used as the glass powder, and one having a softening point lower than the treatment temperature of annealing treatment of a compact to be performed in the annealing step described below is selected and used. In this embodiment, glass powder having a softening point of 420° C. or less, preferably 350° (C or less, specifically glass powder comprising as a main component bismuth oxide (Bi₂O₃) and boron oxide (B₂O₃) is used because the compact is formed of the iron-based amorphous powder as main component powder and is subjected to annealing treatment within a temperature range of from about 450° C. to about 550° C. Glass powder having an average particle diameter (number average particle diameter) smaller than that of the magnetic powder is used as the glass powder. Specifically, glass powder having an average particle diameter of from about 0.1 μm to about 10 μm is used.

The powder A for a magnetic core may comprise a solid lubricant for the purposes of, for example, reducing a friction force between a molding die to be used in the compression molding step described below and the powder A for a magnetic core, reducing a friction force between the respective particles constituting the powder A for a magnetic core, and extending the durability life of the molding die. However, when the blending ratio of the solid lubricant in the powder A for a magnetic core is too high, it becomes difficult to obtain a powder magnetic core (core 10) excellent in magnetic characteristics. Therefore, the maximum blending ratio of the solid lubricant in the powder A for a magnetic core is set to about 1 wt %.

The solid lubricant which may be used is not particularly limited, and there may be used, for example, zinc stearate, calcium stearate, magnesium stearate, barium stearate, lithium stearate, iron stearate, aluminum stearate, stearamide, ethylenebisstearamide, oleamide, ethylene bis oleamide, erucamide, ethylenebiserucamide, lauramide, palmitamide, behenamide, ethylenebiscapramide, ethylenebishydroxystearamide, montanamide, polyethylene, polyethylene oxide, starch, molybdenum disulfide, tungsten disulfide, graphite, boron nitride, polytetrafluoroethylene, lauroyl lysine, or melamine cyanurate. The solid lubricants described above as examples may be used alone or in combination thereof.

[Compression Molding Step]

The compression molding step involves performing compression molding through use of a molding die 30 as schematically illustrated in FIG. 3A and FIG. 3B to provide a cylindrical (ring-shaped) compact serving as a base material of the core 10. Specifically, the powder A for a magnetic core is filled into a cavity defined by a core pin 31, a die 32, and a lower punch 34 as illustrated in FIG. 3A, and is then subjected to compression molding by relatively moving an upper punch 33 so as to be close to the lower punch 34 to provide a compact 6 as illustrated in FIG. 3B. A molding pressure is set to 1,000 MPa or more, preferably 1,500 MPa or more. However, when the molding pressure is increased up to about more than 2,000 MPa, the durability life of the molding die 30 is reduced, and besides the insulating coating 3 is highly likely to suffer from damage or the like. Therefore, the molding pressure is set to from 1,000 MPa to 2,000 MPa, more preferably from 1,500 MPa to 2,000 MPa.

Herein, as described above, in the powder A for a magnetic core of this embodiment, the granulated powder 1 in such a form that the large-diameter particles 2 contained in the magnetic powder wear the fine particles 2 contained in the magnetic powder (see FIG. 1A) is predominant. Therefore, when the powder A for a magnetic core is filled into the cavity of the molding die 30 and pressed, the fine particles 2 are arranged so as to particularly fill gaps between the large-diameter particles 2. As a result, the compact 6 having a dense structure, that is, the compact 6 having a high density can be obtained. In addition, as described above, the surface of each particle of the granulated powder 1 constituting the powder A for a magnetic core is entirely coated with the resin part 5 in a coating form (PVA coating). The resin part 5 is soft and excellent in adhesiveness to others, and hence allows the compact 6 to have higher density and achieve an improvement in shape retention property (chipping resistance).

A granulated powder 1′, which is formed through use of a binder solution having a high viscosity (a viscosity of more than 25 mPa·s) as the binder solution 26 in the granulation step, is schematically illustrated in FIG. 6. As illustrated in the figure, the particle diameter of the granulated powder 1′ is liable to be increased up to about not less than several hundred micrometers because the strength of a resin part 5′ itself, which is obtained by drying the binder solution 26, is relatively increased and a number of the large-diameter particles 2 are bound to each other accordingly. Such coarse granulated powder 1 has a low apparent density while being excellent in fluidity in the molding die 30. As a result, even when the molding pressure is increased, the molding pressure is consumed through friction between the particles 2 of the granulated powder 1. Therefore, it is difficult to obtain the compact 6 having a high density.

[Annealing Step]

The annealing step involves subjecting the compact 6 to annealing treatment through heating at a predetermined temperature for a predetermined time period under an appropriate atmosphere. In this embodiment, in which the compact 6 is formed of the iron-based amorphous powder having been subjected to insulation treatment as main component powder, the temperature of the annealing treatment of the compact 6 is set to from about 450° C. to about 550° C. In addition, the heating time period of the compact 6 is set to such a time period that the compact 6 can sufficiently be heated to its core portion (for example, from about 5 minutes to about 60 minutes) depending on the size of the compact 6. There is no particular limitation on the atmosphere for performing the annealing treatment, and nitrogen, argon, the atmosphere, hydrogen, oxygen, steam, and the like may be used. When a non-oxidizing atmosphere, such as nitrogen or argon, is adopted, a situation in which the core 10 (powder magnetic core) is increased in iron loss owing to oxidation and expansion of the iron-based amorphous powder can be prevented to the extent possible.

Through the annealing treatment as described above, a strain accumulated in the particles 3 of the iron-based amorphous powder is appropriately removed, and the core 10 serving as a powder magnetic core excellent in magnetic characteristics is obtained. In addition, when the annealing treatment is performed at the above-mentioned temperature, the glass powder contained in the compact 6 softens and melts, and is then solidified between the adjacent particles of the granulated powder 1. As a result, the core 10 having a high binding force between the adjacent particles and thus high strength can be obtained.

In the foregoing, the powder A for a magnetic core according to the embodiment of the present invention and the core 10 as the powder magnetic core produced using the powder A for a magnetic core have been described. However, the powder A for a magnetic core and the core 10 as the powder magnetic core may be appropriately modified within the range not departing from the gist of the present invention.

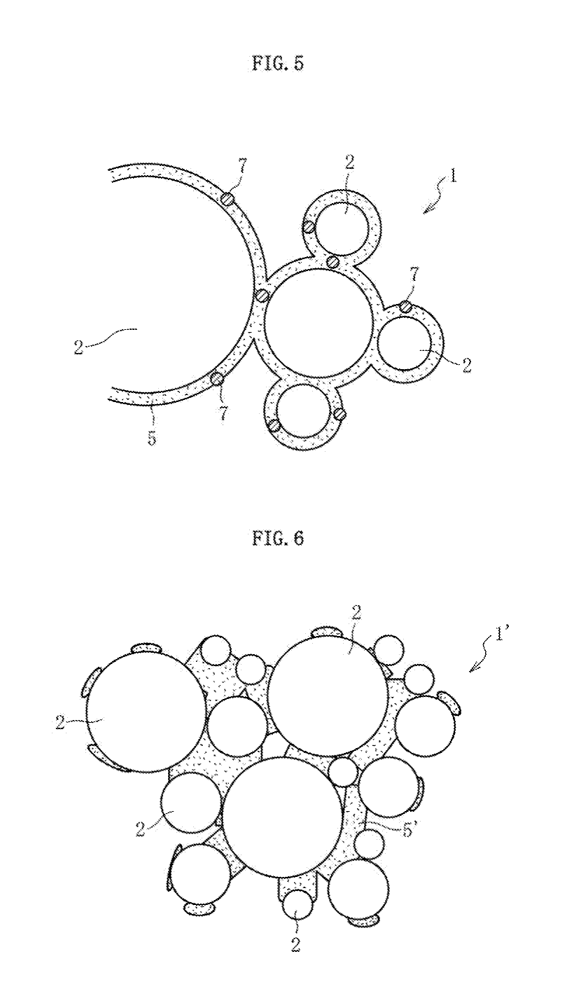

In the above-mentioned embodiment, the granulated powder 1 and the glass powder are mixed in the mixing step after the granulation step to provide the powder A for a magnetic core comprising the granulated powder 1 and the glass powder, but for example, it is appropriate to disperse the glass powder in the binder solution 26 to be used in the production of the granulated powder 1 in the granulation step to incorporate the glass powder in the powder A for a magnetic core. In this case, as schematically illustrated in FIG. 5, glass powder 7 is supported on the granulated powder 1 (strictly speaking, retained in the resin part 5 constituting the granulated powder 1). With this, the glass powder 7 can uniformly be dispersed and retained in the resin part 5, and hence variation in strength in each powder magnetic core (core 10) and further variation between powder magnetic cores can be prevented to the extent possible. Therefore, a powder magnetic core having high strength and high reliability can stably be mass produced.

In addition, in the above-mentioned embodiment, the granulated powder 1 is produced through use of the tumbling fluidized bed apparatus 20, but the production method for the granulated powder 1 is not limited thereto. Specifically, the granulated powder 1 may be produced by adding the binder solution 26 to the magnetic powder 2 filled in a container and mixing the resultant, followed by eliminating (drying) the solvent of the binder solution 26. In addition, the granulated powder 1 may be produced with a device called a spray dryer. A spray dryer is a device in which a mixed solution of fine powder and a solution obtained by diluting a binder is centrifugally sprayed from a nozzle configured to rotate at high speed in an upper portion of a heating and drying chamber, and the discharged liquid droplets are rapidly dried while falling in a swirling manner, and thus spherical granulated powder is produced. For example, FL-12 manufactured by Ohkawara Kakohki Co., Ltd. may be used.

In addition, in the compression molding of the compact 6, any one or both of a die lubrication molding method involving allowing a lubricant, such as zinc stearate, to adhere to an inner wall surface (cavity-defining surface) of the molding die 30 and a warm compaction method involving heating the molding die 30 up to about 150° C. may be adopted. With this, the compact 6 having a higher density is obtained easily.

### EXAMPLES

A first confirmation test was performed in order to examine an influence of the viscosity of the binder solution 26 (PVA aqueous solution) to be used in production of the granulated powder 1 on the magnetic characteristics of a powder magnetic core. In the test, ring-shaped test pieces according to Examples 1 to 4 were each produced through use of a powder for a magnetic core to which the present invention was applied, and ring-shaped test pieces according to Comparative Examples 1 and 2 were each produced through use of a powder for a magnetic core to which the present invention was not applied. Production procedures of the test pieces according to Examples 1 to 4 and Comparative Examples 1 and 2 are described below.

### Example 1

(A) Iron-based amorphous powder having an Fe—Cr—Si—B—C-based composition and having a particle size distribution falling within a range of from 1 μm to 200 μm was prepared, and the iron-based amorphous powder was subjected to insulation treatment. Thus, magnetic powder in which the surfaces of the respective particles constituting the iron-based amorphous powder were each coated with an insulating coating was obtained. A material for forming the insulating coating was sodium silicate, and the thickness of the insulating coating was from about 5 nm to about 50 nm. The insulating coating was formed with the tumbling fluidized bed apparatus 20 schematically illustrated in FIG. 2, more specifically a tumbling fluidized bed apparatus MP-01 manufactured by Powrex Corp. In addition, PVA in which a polymerization degree and a saponification degree had been adjusted was dissolved in water as a solvent. Thus, a PVA aqueous solution containing 10 wt % of PVA and having a viscosity of 3 mPa·s was obtained.

(B) The resultant magnetic powder and PVA aqueous solution were loaded and filled in the tumbling fluidized bed apparatus, and then the tumbling fluidized bed apparatus was operated. Thus, granulated powder in which the particles of the magnetic powder were bound to each other with a resin part in a coating form (PVA coating) was obtained.

(C) Glass powder and zinc stearate serving as a solid lubricant were added to and mixed with the resultant granulated powder each at a ratio of 0.5 wt %. Thus, a powder for a magnetic core comprising a mixture of the various powders described above was obtained. After that, the resultant powder for a magnetic core was subjected to compression molding at room temperature to provide a compact. Glass powder containing as a main component bismuth oxide (Bi₂O₃) and boron oxide (B₂O₃) and having a softening point of about 420° C. and an average particle diameter of about 2 μm was used as the glass powder. In addition, a molding pressure of the powder for a magnetic core was set to 1,470 MPa.

(D) The resultant compact was subjected to annealing treatment at 480° C. for 15 minutes under the atmosphere. Thus, the ring-shaped test piece of Example 1 (measuring 20 mm in outer diameter×12 mm in inner diameter×6 mm in height) was obtained.

The test pieces according to Examples 2 to 4 and Comparative Examples 1 and 2 were each produced by the same procedures as in Example 1 except that a PVA aqueous solution having the following viscosity was prepared in the above-mentioned procedure (A).
Example 2: 8 mPa·s
Example 3: 16 mPa·s
Example 4: 25 mPa·s
Comparative Example 1: 34 mPa·s
Comparative Example 2:47 mPa·s

For each of the test pieces according to Examples 1 to 4 and Comparative Examples 1 and 2 produced as described above, a density was calculated from the dimensions and weight of each test piece. In addition, the test pieces were each measured for a magnetic permeability, an iron loss, and a magnetic flux density. The results are shown together in Table 1. The magnetic permeability, iron loss, and magnetic flux density of the test pieces were each measured with a B-H analyzer SY-8218 manufactured by Iwatsu Test Instruments Corporation. The magnetic permeability and the iron loss were each a value measured at 100 kHz and 0.1 T, and the magnetic flux density was a value measured at 10 Hz and 5 kA/m. The same applies to second and third confirmation tests described below.

TABLE 1

| | Viscosity of | | Mag- | | Magnetic |
|---|---|---|---|---|---|
| | PVA aqueous | | netic | Iron | flux |
| | solution | Density | perme- | loss | density |
| Test piece | [mPa · s] | [g/cm³] | ability | [kW/m³] | [T] |
| Example 1 | 3 | 5.44 | 60 | 515 | 0.29 |
| Example 2 | 8 | 3.45 | 60 | 520 | 0.29 |
| Example 3 | 16 | 5.42 | 58 | 535 | 0.28 |
| Example 4 | 25 | 5.4 | 57 | 549 | 0.28 |
| Comparative | 34 | 5.2 | 45 | 620 | 0.24 |
| Example 1 | | | | | |
| Comparative | 47 | 5.11 | 27 | 641 | 0.24 |
| Example 2 | | | | | |

As is apparent also from Table 1, the test pieces of Examples 1 to 4 obtained by applying the present invention each have a high density and excellent magnetic characteristics as compared to the test pieces of Comparative Examples 1 and 2 obtained without applying the present invention. This reveals that it is effective to control the viscosity of the binder solution to be used in production of the granulated powder to an appropriate value for achieving an increase in density of a compact formed of the powder for a magnetic core comprising the granulated powder as a main component, and by extension, achieving improvements in magnetic characteristics of a powder magnetic core.

Next, a second confirmation test was performed in order to demonstrate that incorporation of a predetermined amount of the glass powder in the powder for a magnetic core is advantageous for achieving an increase in strength of the powder magnetic core. In the test, ring-shaped test pieces produced through use of a powder for a magnetic core to which the present invention was applied (Examples 5 to 14) and a ring-shaped test piece produced through use of a powder for a magnetic core to which the present invention was not applied (Comparative Example 3) were prepared. Production procedures of the test pieces according to Examples 5 to 14 and Comparative Example 3 are briefly described below.

### [Example 5] to [Example 9]

The test pieces according to Examples 5 to 9 were each obtained by the same procedures as in Example 1 except that, in the above-mentioned procedures (A) to (D), a PVA aqueous solution having a viscosity of 15 mPa·s was prepared in the procedure (A) and the glass powder was blended (dispersed) in the PVA aqueous solution to be used in production of the granulated powder so that the blending ratio of the glass powder with respect to the iron-based amorphous powder was a value shown in Table 2 below in the procedure (B).

### [Example 10] to [Example 14]

The test pieces according to Examples 10 to 14 were each obtained by the same procedures as in Example 1 except that, in the above-mentioned procedures (A) to (D), a PVA aqueous solution having a viscosity of 18 mPa·s was prepared in the procedure (A) and the glass powder was incorporated in the powder for a magnetic core so that the blending ratio of the glass powder with respect to the granulated powder (iron-based amorphous powder) was a value shown in Table 2 below in the procedure (C).

### Comparative Example 3

The test piece according to Comparative Example 3 was obtained by the same procedures as in Example 1 except that, in the above-mentioned procedures (A) to (D), a PVA aqueous solution having a viscosity of 35 mPa·s was prepared in the procedure (A) and powder for a magnetic core free from the glass powder was subjected to compression molding to provide a compact in the procedure (C).

For each of the test pieces according to Examples 5 to 14 and Comparative Example 3 produced as described above, a density was calculated from the dimensions and weight of each test piece. In addition, the test pieces were each measured for a radial crushing strength and a magnetic permeability. The results are shown together in Table 2. The radial crushing strength was measured as follows: a compression force in a reduced diameter direction was applied to an outer circumferential surface of each ring-shaped test piece through use of a precision universal tester Autograph manufactured by Shimadzu Corporation, and the radial crushing strength was calculated by dividing the compression force by a broken cross-sectional area. The same applies to the third confirmation test described below.

TABLE 2

| | Blending | | | Radial | Mag- |
|---|---|---|---|---|---|
| | amount of | Blending | | crushing | netic |
| | glass powder | method for | Density | strength | perme- |
| Test piece | [wt %] | glass powder | [g/cm³] | [MPa] | ability |
| Example 5 | 0.1 | Blended | 5.49 | 5 | 62 |
| | | in PVA | | | |
| | | aqueous | | | |
| | | solution | | | |
| Example 6 | 0.3 | ↑ | 5.46 | 7 | 60 |
| Example 7 | 0.5 | ↑ | 5.44 | 11 | 60 |
| Example 8 | 0.7 | ↑ | 5.41 | 14 | 57 |
| Example 9 | 1 | ↑ | 5.37 | 12 | 52 |
| Example 10 | 0.1 | Blended | 5.48 | 3 | 62 |
| | | after | | | |
| | | granulation | | | |
| Example 11 | 0.3 | ↑ | 5.46 | 4 | 59 |
| Example 12 | 0.5 | ↑ | 5.43 | 6 | 59 |
| Example 13 | 0.7 | ↑ | 5.41 | 7 | 58 |
| Example 14 | 1 | ↑ | 5.36 | 7 | 52 |
| Comparative | 0 | — | 5.51 | 2 | 64 |
| Example 3 | | | | | |

As is apparent also from the test results shown in Table 2, the test piece of Comparative Example 3 produced through use of the powder for a magnetic core free from the glass powder has a high density as compared to the test pieces of Examples 5 to 14 each produced through use of the powder for a magnetic core containing the glass powder, but is significantly inferior in radial crushing strength to the test pieces of Examples 5 to 14. This reveals that it is advantageous to incorporate a predetermined amount of the glass powder in the powder for a magnetic core for achieving an increase in strength of the powder magnetic core. In addition, comparison between Examples 5 to 9 and Examples 10 to 14 reveals that it is particularly advantageous to produce the granulated powder through use of the PVA aqueous solution having blended (dispersed) therein the glass powder for achieving an increase in strength of the powder magnetic core. As is apparent also from Table 2, the magnetic permeability of the powder magnetic core reduces with an increase in blending amount (blending ratio) of the glass powder. The reduction, which is caused by a reduction in blending ratio of the magnetic powder (iron-based amorphous powder) in the powder magnetic core in accordance with an increase in blending amount of the glass powder, falls within an acceptable range.

A third confirmation test was performed in order to examine whether or not a production method for the granulated powder causes a difference in density, radial crushing strength, and magnetic characteristics (magnetic permeability) of the powder magnetic core. In the confirmation test, test pieces according to Examples 15 to 17 were additionally produced. The production procedures are as described below.

### Example 151

The test piece according to Example 15 was obtained by the same procedures as in Example 1 except that, in the above-mentioned procedures (A) to (D), a PVA aqueous solution having a viscosity of 20 mPa·s was prepared in the procedure (A), and the granulated powder was produced by mixing the magnetic powder and the PVA aqueous solution having dispersed therein the glass powder (more specifically, the PVA aqueous solution in which the glass powder was dispersed so that the blending ratio of the glass powder with respect to the iron-based amorphous powder was 0.5 wt %) with a powder mixer RMH-30 manufactured by Aichi Electric Co., Ltd. in the procedure (B). The powder mixer is configured to produce the granulated powder by spraying the PVA aqueous solution into a container in which the magnetic powder has been loaded while heating, rotating, and rocking the container, to thereby mix the magnetic powder and the PVA aqueous solution.

### Example 16

The test piece according to Example 16 was obtained by the same procedures as in Example 1 except that, in the above-mentioned procedures (A) to (I)), a PVA aqueous solution having a viscosity of 15 mPa·s was prepared in the procedure (A) and the granulated powder was produced by directly mixing the magnetic powder and the PVA aqueous solution having dispersed therein the glass powder (more specifically, the PVA aqueous solution in which the glass powder was dispersed so that the blending ratio of the glass powder with respect to the granulated powder was 0.5 wt %) in a beaker in the procedure (B).

### Example 17

The test piece according to Example 17 was obtained by the same procedures as in Example 1 except that, in the above-mentioned procedures (A) to (D), a PVA aqueous solution containing 20 wt % of PVA and having a viscosity of 18 mPa·s was prepared in the procedure (A) and the granulated powder was produced by loading the magnetic powder and the PVA aqueous solution having dispersed therein the glass powder (more specifically, the PVA aqueous solution in which the glass powder was dispersed so that the blending ratio of the glass powder with respect to the granulated powder was 0.5 wt %) in a spray dryer FL-12 manufactured by Ohkawara Kakohki Co., Ltd. and operating the spray dryer in the procedure (B).

For each of the test pieces according to Examples 15 to 17 produced as described above, a density was calculated from the dimensions and weight of each test piece. In addition, the test pieces were each measured for a radial crushing strength and a magnetic permeability. The results are shown together in Table 3. The density, radial crushing strength, and magnetic permeability of the test piece according to Example 7 are also shown in Table 3 for comparison with Examples 15 to 17.

TABLE 3

| | | Blending amount | Blending | | Radial crushing | |
|---|---|---|---|---|---|---|
| | Production method for | of glass powder | method for | Density | strength | Magnetic |
| Test piece | granulated powder | [wt %] | glass powder | [g/cm³] | [MPa] | permeability |
| Example 7 | Tumbling fluidized | 0.5 | Blended in | 5.44 | 11 | 60 |
| | bed apparatus_{(*1)} | | PVA aqueous | | | |
| | | | solution | | | |
| Example 15 | Rotating and rocking | ↑ | ↑ | 5.43 | 11 | 59 |
| | mixer_{(*2)} | | | | | |
| Example 16 | Direct mixing with | ↑ | ↑ | 5.32 | 8 | 48 |
| | PVA aqueous solution | | | | | |
| Example 17 | Spray dryer_{(*3)} | ↑ | ↑ | 5.35 | 9 | 51 |

_{*1}Using a tumbling fluidized bed apparatus MP-01 manufactured by Powrex Corp.
_{*2}Using a powder mixer RMH-30 manufactured by Aichi Electric Co., Ltd.
_{*3}Using a spray dryer FL-12 manufactured by Ohkawara Kakohki Co., Ltd.

As is apparent also from Table 3 (and Table 1 above), the powder for a magnetic core to which the present invention is applied enables production of the powder magnetic core which has a high density and is excellent in magnetic permeability irrespective of the production method for the granulated powder. In particular, when the granulated powder is produced with a tumbling fluidized bed apparatus, the powder magnetic core having a high density, high strength, and a high magnetic permeability can be produced.

From the results of the confirmation tests described above, it is revealed that the use of the powder for a magnetic core according to the present invention enables production of the powder magnetic core which has high strength and is excellent in magnetic characteristics (particularly, magnetic permeability).

### REFERENCE SIGNS LIST

1 granulated powder
2 particle of magnetic powder
3 particle of iron-based amorphous powder
4 insulating coating
5 resin part
6 compact
10 core (powder magnetic core)
A powder for magnetic core

1. A powder for a magnetic core for producing a powder magnetic core through annealing treatment of a compact,
the powder for a magnetic core comprising: as a main component granulated powder obtained by granulating iron-based amorphous powder having been subjected to insulation treatment and having a particle size distribution falling within a range of from 1 μm to 200 μm; and glass powder having a softening point lower than a temperature of the annealing treatment,
wherein the granulated powder is obtained by binding particles of the iron-based amorphous powder to each other through use of a PVA aqueous solution having a viscosity of from 3 mPa·s to 25 mPa·s.

2. The powder for a magnetic core according to claim 1, wherein the glass powder is supported on the granulated powder.

3. The powder for a magnetic core according to claim 1, wherein a weight ratio of the glass powder with respect to the iron-based amorphous powder is set to from 0.1 wt % to 1 wt %.

4. The powder for a magnetic core according to claim 1, wherein the glass powder comprises as a main component bismuth oxide and boron oxide.

5. A powder magnetic core, which is formed through annealing treatment of a compact formed of the powder for a magnetic core of claim 1.

6. A method of producing a powder for a magnetic core for producing a powder magnetic core through annealing treatment of a compact,
the powder for a magnetic core comprising: as a main component granulated powder obtained by granulating iron-based amorphous powder having been subjected to insulation treatment and having a particle size distribution falling within a range of from 1 μm to 200 μm; and glass powder having a softening point lower than a temperature of the annealing treatment,
the method comprising producing the granulated powder by binding particles of the iron-based amorphous powder to each other through use of a PVA aqueous solution having a viscosity of from 3 mPa·s to 25 mPa·s.

7. The method of producing a powder for a magnetic core according to claim 6, wherein the binding of the particles of the iron-based amorphous powder to each other is performed by eliminating a solvent component of the PVA aqueous solution supplied into a container in which the iron-based amorphous powder is stirred in a floating state.

8. The method of producing a powder for a magnetic core according to claim 6, wherein the PVA aqueous solution to be used has dispersed therein the glass powder.
